(19) United States
(12) Patent Application Publication
(10) Pub. No.: US 2012/0165425 A1
(43) Pub. Date: Jun. 28, 2012

(54) Polycarbonate Resin Composition and Molded Product Using the Same

(75) Inventors: Jung-Eun PARK, Uiwang-si (KR); Doo-Han HA, Uiwang-si (KR)

(73) Assignee: CHEIL INDUSTRIES INC., Gumi-si (KR)

(21) Appl. No.: 13/191,514

(22) Filed: Jul. 27, 2011

(30) Foreign Application Priority Data
Dec. 27, 2010 (KR) 10-2010-0135698

(51) Int. Cl. C08L 51/04

(52) U.S. Cl. 523/122; 525/67; 524/504

(57) ABSTRACT

A polycarbonate resin composition including (A) a mixed resin including (A1) a polycarbonate resin; (A2) a polybutylene terephthalate resin; and (A3) a polycarbonate-polysiloxane copolymer; and (B) a graft copolymer including an unsaturated compound including an acrylic-based compound graft-polymerized into a rubber.

### CROSS-REFERENCE TO RELATED APPLICATIONS

This application claims priority under 35 USC Section 119 to and the benefit of Korean Patent Application No. 10-2010-0135698 filed in the Korean Intellectual Property Office on Dec. 27, 2010, the entire disclosure of which is incorporated herein by reference.

### FIELD OF THE INVENTION

The present invention relates to a polycarbonate resin composition and a molded product using the same.

### BACKGROUND

Polyester resins have excellent mechanical characteristics, electric characteristics, and chemical resistance. Polyester resins can be easily molded due to their fast crystallization rate, and thus can be used as thermosetting resins for injection molding applications and metal-substituting materials. Polyester resins are widely used for automobile, electric, and electronic industries.

However, since the polyester resins have a glass transition temperature of 40° C. to 60° C., they have a low thermal distortion temperature and low impact resistance at room temperature and low temperatures.

Polyester/polycarbonate alloy resins can be used in industrial applications requiring impact resistance. Polyester/polycarbonate alloy resins, however, may not provide both impact resistance and heat resistance at low temperatures.

Acrylonitrile-butadiene-styrene copolymer (ABS) can be added to a polyester/polycarbonate alloy resin to improve the impact resistance. This method, however, decreases heat resistance. Therefore, there is limitation in using these materials for automobiles, which require high heat resistance.

Also, an ethylene-propylene copolymer, an ethylene-propylene-diene copolymer, or a methylmethacrylate-butadiene-styrene (MBS) copolymer can be added to a polyester/polycarbonate alloy resin to improve the impact resistance. Adding the impact-reinforcing agent to provide impact resistance, however, can significantly decrease heat resistance and deteriorate fluidity.

### SUMMARY

One embodiment provides a polycarbonate resin composition which can have excellent heat resistance and low-temperature impact resistance and can provide a glossy surface. Another embodiment provides a molded product made of the polycarbonate resin composition.

According to one embodiment, a polycarbonate resin composition is provided that includes (A) a mixed resin including (A1)) a polycarbonate resin; (A2) a polybutylene terephthalate resin; and (A3) a polycarbonate-polysiloxane copolymer; and (B) a graft copolymer including an unsaturated compound including an acrylic-based compound graft-polymerized into a rubber.

The polycarbonate resin composition can include the graft copolymer (B) in an amount of about 8 to about 25 parts by weight based on 100 parts by weight of the mixed resin (A).

The mixed resin (A) may include about 20 to about 80 wt % of the polycarbonate resin (A1); about 15 to about 70 wt % of the polybutylene terephthalate resin (A2); and about 5 to about 30 wt % of the polycarbonate-polysiloxane copolymer (A3).

The polycarbonate-polysiloxane copolymer (A3) may include about 1 to about 99 wt % of a polycarbonate block and about 1 to about 99 wt % of a polysiloxane block, and the polycarbonate-polysiloxane copolymer (A3) may have a weight average molecular weight of about 10,000 to about 30,000 g/mol.

The rubber may include a diene-based compound, a silicon-based compound, or a combination thereof, and the unsaturated compound may further include a heterocyclic compound, an aromatic vinyl compound, a vinyl cyanide compound, or a combination thereof.

The polycarbonate resin composition may further include at least one additive such as but not limited to an antibacterial agent, a heat stabilizer, an antioxidant, a release agent, a light stabilizer, an inorganic material additive, a surfactant, a coupling agent, a plasticizer, an admixture, a stabilizer, a lubricant, an antistatic agent, a coloring aid, a flame proofing agent, a weather-resistance agent, a colorant, an ultraviolet (UV) absorber, an ultraviolet (UV) blocking agent, a flame retardant, a filler, or a combination thereof.

According to another embodiment, a molded product using the polycarbonate resin composition is provided.

Hereinafter, further embodiments will be described in detail.

The polycarbonate resin composition can have excellent heat resistance and low-temperature impact resistance and can provide high exterior gloss to an injection molded product. The polycarbonate resin composition accordingly may be used for diverse molded products, such as electronic parts, automobile parts, general products, and the like. In exemplary embodiments, the polycarbonate resin composition may be used for exterior components of an automobile exposed to outside environments, such as bumpers.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” may refer to one substituted with at least a substituent including halogen (F, Cl, Br, I), hydroxy, C1 to C20 alkoxy, nitro, cyano, amine, imino, azido, amidino, hydrazino, hydrazono, carbonyl, carbamyl, thiol, ester, ether, carboxyl or a salt thereof, sulfonic acid or a salt thereof, phosphoric acid or a salt thereof, C1 to C20 alkyl, C2 to C20 alkenyl, C2 to C20 alkynyl, C6 to C30 aryl, C3 to C20 cycloalkyl, C3 to C20 cycloalkenyl, C3 to C20 cycloalkynyl, C2 to C20 heterocycloalkyl, C2 to C20 heterocycloalkenyl, C2 to C20 heterocycloalkynyl, C3 to C30 heteroaryl, or a combination thereof.

As used herein, when a specific definition is not otherwise provided, the prefix “hetero” may refer to at least one heteroatom including N, O, S, P or a combination thereof, in place of one or more carbon ring atoms.

As used herein, when a specific definition is not otherwise provided, the term “(meth)acrylate” may refer to both “acrylate” and “methacrylate.”.

A polycarbonate resin composition according to one embodiment includes (A) a mixed resin including (A1) a polycarbonate resin, (A2) a polybutylene terephthalate resin, and (A3) a polycarbonate-polysiloxane copolymer, and (B) a graft copolymer including an unsaturated compound including an acrylic-based compound graft-polymerized into a rubber.

Exemplary components included in the polycarbonate resin composition according to embodiments will hereinafter be described in detail.

(A) Mixed Resin

(A1) Polycarbonate Resin

The polycarbonate resin may be prepared by reacting one or more diphenols of the following Chemical Formula 1 with phosgene, halogen acid ester, carbonate ester, or a combination thereof.

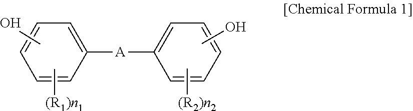

In Chemical Formula 1,

A is a single bond, substituted or unsubstituted C1 C1 to C30 linear or branched alkylene, substituted or unsubstituted C2 to C5 alkenylene, substituted or unsubstituted C2 to C5 alkylidene, substituted or unsubstituted C1 to C30 linear or branched haloalkylene, substituted or unsubstituted C5 to C6 cycloalkylene, substituted or unsubstituted C5 to C6 cycloalkenylene, substituted or unsubstituted C5 to C10 cycloalkylidene, substituted or unsubstituted C6 to C30 arylene, substituted or unsubstituted C1 to C20 linear or branched alkoxylene, halogen acid ester, carbonate ester, CO, S, or SO₂,

each R₁ and R₂ is the same or different and each is independently substituted or unsubstituted C1 to C30 alkyl or substituted or unsubstituted C6 to C30 aryl, and

n₁ and n₂ are each independently integers ranging from 0 to 4.

The diphenols represented by the above Chemical Formula 1 may be used in combinations to constitute repeating units of the polycarbonate resin. Exemplary diphenols include without limitation hydroquinone, resorcinol, 4,4′-dihydroxydiphenyl, 2,2-bis(4-hydroxyphenyl)propane (referred to as “bisphenol-A”), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In one embodiment, the diphenol may include 2,2-bis(4-hydroxyphenyl)-propane, 2,2-bis(3,5-dichloro-4-hydroxyphenyl)-propane, or 1,1-bis(4-hydroxyphenyI)-cyclohexane. In another embodiment, the diphenol may include 2,2-bis(4-hydroxyphenyl)-propane.

In one embodiment, the polycarbonate resin has a weight average molecular weight ranging from about 10,000 to about 200,000 g/mol, for example a weight average molecular weight ranging from about 15,000 to about 80,000 g/mol, but is not limited thereto.

The polycarbonate resin may be a mixture of polycarbonate resins obtained using two or more diphenols that are different from each other. The polycarbonate resin may be a linear polycarbonate resin, a branched polycarbonate resin, a polyester carbonate copolymer, or a combination thereof.

The linear polycarbonate resin may include a bisphenol-A based polycarbonate resin. The branched polycarbonate resin may include one produced by reacting a multi-functional aromatic compound such as trimellitic anhydride, trimellitic acid, and the like with one or more diphenols and a carbonate. The multi-functional aromatic compound may be included in an amount of about 0.05 to about 2 mol % based on the total weight of the branched polycarbonate resin. The polyester carbonate copolymer resin may include one produced by reacting a difunctional carboxylic acid with one or more diphenols and a carbonate. The carbonate may include a diaryl carbonate such as diphenyl carbonate, and ethylene carbonate.

The mixed resin may include the polycarbonate resin in an amount of about 20 to about 80 wt %, for example about 30 to about 70 wt %, based on a total weight of the mixed resin including the polycarbonate resin, polybutylene terephthalate resin, and polycarbonate-polysiloxane copolymer.

In some embodiments, the mixed resin may include the polycarbonate resin in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the polycarbonate resin can be in a range from about any of the foregoing amounts to about any other of the foregoing amounts.

When the mixed resin includes the polycarbonate resin in an amount within the above range, the polycarbonate resin composition can have improved impact resistance, heat resistance, workability, and the like.

(A2) Polybutylene Terephthalate Resin

The polybutylene terephthalate resin is an aromatic polyester resin and can be obtained by condensation polymerization of 1,4-butanediol monomer with terephthalic acid or dimethyl terephthalate monomer through an esterfication reaction or an ester exchange reaction.

To increase impact strength, the polybutylene terephthalate resin may be copolymerized with polytetramethylene glycol (PTMG), polyethylene glycol (PEG), polypropylene glycol (PPG), low-molecular aliphatic polyester or aliphatic polyamide, or it may be used in the form of a modified polybutylene terephthalate resin by being blended with an impact-improving component.

The polybutylene terephthalate resin may have an intrinsic viscosity [η] of about 0.35 to about 1.5 dl/g, for example about 0.5 to about 1.3 dl/g, when it is measured with o-chloro phenol at 25° C. When the polybutylene terephthalate resin has an intrinsic viscosity within the above range, the mechanical strength and formability can be excellent.

The mixed resin can include the polybutylene terephthalate resin in an amount of about 15 to about 70 wt %, for example about 23 to about 70 wt %, based on a total weight of the mixed resin including the polycarbonate resin, polybutylene terephthalate resin, and polycarbonate-polysiloxane copolymer.

In some embodiments, the mixed resin may include the polybutylene terephthalate resin in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the polybutylene terephthalate resin can be in a range from about any of the foregoing amounts to about any other of the foregoing amounts.

When the mixed resin includes the polybutylene terephthalate resin in an amount within the above range, the heat resistance and impact resistance may be excellent and the chemical resistance and weather resistance may be improved.

(A3) Polycarbonate-Polysiloxane Copolymer

The polycarbonate-polysiloxane copolymer includes a polycarbonate block and a polysiloxane block.

The polycarbonate block includes a structural unit derived from the aforementioned polycarbonate resin (A).

The polysiloxane block may include a structural unit represented by the following Chemical Formula 2.

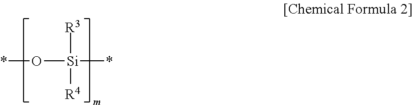

In Chemical Formula 2,

R³ and R⁴ are the same or different and are independently hydrogen, substituted or unsubstituted C1 to C20 alkyl, substituted or unsubstituted C2 to C20 alkenyl, substituted or unsubstituted C2 to C20 alkynyl, substituted or unsubstituted C1 to C20 alkoxy, substituted or unsubstituted C3 to C30 cycloalkyl, substituted or unsubstituted C3 to C30 cycloalkenyl, substituted or unsubstituted C3 to C30 cycloalkynyl, substituted or unsubstituted C6 to C30 aryl, substituted or unsubstituted C6 to C30 aryloxy, or NRR′ (wherein R and R′ are the same or different and are independently hydrogen or substituted or unsubstituted C1 to C20 alkyl), and

2≦m<10,000.

In the above Chemical Formula 2, 2≦m<10,000, for example 2≦m<1,000. When m is within the above range, impact resistance can be excellent and the copolymer can have a viscosity suitable for extrusion processes.

The polycarbonate-polysiloxane copolymer may include about 1 wt % to about 99 wt % of the polycarbonate block and about 1 wt % to about 99 wt % of the polysiloxane block, for example about 40 wt % to about 80 wt % of the polycarbonate block and about 20 wt % to about 60 wt % of the polysiloxane block.

In some embodiments, the polycarbonate-polysiloxane copolymer may include the polycarbonate block in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polycarbonate block can be in a range from about any of the foregoing amounts to about any other of the foregoing amounts.

In some embodiments, the polycarbonate-polysiloxane copolymer may include the polysiloxane block in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polysiloxane block can be in a range from about any of the foregoing amounts to about any other of the foregoing amounts.

When the polycarbonate block and the polysiloxane block are included in an amount in the above ratio, impact resistance may be improved.

The polycarbonate-polysiloxane copolymer may have a weight average molecular weight of about 10,000 g/mol to about 30,000 g/mol, for example about 15,000 g/mol to about 22,000 g/mol. When the polycarbonate-polysiloxane copolymer has a weight average molecular weight within the above range, low temperature impact resistance can be excellent.

The addition of the polycarbonate-polysiloxane copolymer to a polycarbonate resin composition not only makes it possible to obtain an excellent impact-reinforcing effect at low temperature although a small amount of a graft copolymer, which will be described later, is used, but also can improve heat resistance due to the use of the graft copolymer in such a small amount.

The mixed resin can include the polycarbonate-polysiloxane copolymer in an amount of about 5 to about 30 wt %, for example about 7 to about 15 wt %, based on the total weight of the mixed resin including the polycarbonate resin, polybutylene terephthalate resin, and polycarbonate-polysiloxane copolymer.

In some embodiments, the mixed resin may include the polycarbonate-polysiloxane copolymer in an amount of about 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the polycarbonate-polysiloxane copolymer can be in a range from about any of the foregoing amounts to about any other of the foregoing amounts.

When the mixed resin includes the polycarbonate-polysiloxane copolymer in an amount within the above range, low-temperature impact resistance, heat resistance and physical balance of workability can be excellent.

(B) Graft Copolymer

The graft copolymer may act as an impact-reinforcing agent in the polycarbonate resin composition.

The graft copolymer is a copolymer wherein an unsaturated compound including an acrylic-based compound is graft-polymerized into a rubber. Also, the graft copolymer may have a core-shell structure in which the unsaturated compound is grafted into the core structure of the rubber so as to form a hard shell.

Exemplary rubbers may include without limitation diene-based compounds, silicon-based compounds, and the like, and combinations thereof. In exemplary embodiments, the rubber includes a diene-based compound.

Exemplary diene-based compounds may include without limitation butadiene, isoprene, polymers thereof, and the like, and combinations thereof. Exemplary diene polymers may include without limitation styrene-butadiene polymers, acrylonitrile-butadiene polymers, and the like, and combinations thereof.

Exemplary silicon-based compounds may include without limitation hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like, and combinations thereof. In addition, a curing agent such as but not limited to trimethoxymethylsilane, triethoxyphenylsilane, tetramethoxysilane, tetraethoxysilane, and the like, and combinations thereof may be added.

The rubber can have an average particle diameter ranging from about 0.4 to about 1 μm. Using a rubber with an average particle diameter within this range can provide a balance between impact resistance and coloring properties.

Exemplary acrylic-based compounds (which are a type of the unsaturated compounds that can form a shell of a core-shell structure) may include without limitation (meth)acrylic acid alkyl esters, (meth)acrylic acid esters, and the like, and combinations thereof. As used herein, the alkyl of the (meth)acrylic acid alkyl ester is a C1 to C10 alkyl. Non-limiting examples of the (meth)acrylic acid alkyl ester include methyl(meth)acrylate, ethyl(meth)acrylate, propyl(meth)acrylate, butyl(meth)acrylate, and the like, and combinations thereof. In exemplary embodiments, the (meth)acrylic acid alkyl ester includes methyl(meth)acrylate.

The unsaturated compound may further include a heterocyclic compound, an aromatic vinyl compound, a vinyl cyanide compound, or a combination thereof, in addition to the acrylic-based compound

Exemplary heterocyclic compounds may include without limitation maleic anhydride, C1 to C4 alkyl- or phenyl-N-substituted maleimide, and the like, and combinations thereof.

Exemplary aromatic vinyl compounds may include without limitation styrene, C1 to C10 alkyl substituted styrene, halogen substituted styrene, and the like, and combinations thereof. Exemplary C1 to C10 alkyl substituted styrene may include without limitation o-ethyl styrene, m-ethyl styrene, p-ethyl styrene, α-methyl styrene, and the like, and combinations thereof.

Exemplary vinyl cyanide compounds may include without limitation acrylonitrile, methacrylonitrile, ethacrylonitrile, and the like, and combinations thereof. The graft copolymer may have an average particle diameter of about 0.1 to about 0.5 μm. When the graft copolymer has an average particle diameter within the above range, the graft copolymer may be well dispersed so that when an impact is applied from the outside, the graft copolymer may easily absorb the impact to provide an impact-reinforcing effect.

The graft copolymer may include the rubber in an amount of about 20 to about 80 wt %, for example about 30 to about 70 wt %, and the unsaturated compound in an amount of about 20 to about 80 wt %, for example about 30 to about 70 wt %.

In some embodiments, the graft copolymer may include the rubber in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the rubber can be in a range from about any of the foregoing amounts to about any other of the foregoing amounts.

In some embodiments, the graft copolymer may include the unsaturated compound in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the unsaturated compound can be in a range from about any of the foregoing amounts to about any other of the foregoing amounts.

Within the graft copolymer includes the rubber and the unsaturated compound in an amount within the above ratio, the compatibility with the polycarbonate resin may be excellent to maximize the impact reinforcing effect. In addition, the composition may have good injection stability and high glossy characteristics.

Since the unsaturated compound grafted into the rubber does not include a reactive functional group such as glycidyl methacrylate and maleic anhydride but includes non-reactive functional groups, there can be minimal or no color change during injection, minimal or no gas generation, and minimal or no hazy appearance observed in an injection molded product. Therefore, the composition may be used for a paintless product.

The polycarbonate resin composition may include the graft copolymer in an amount of about 8 to about 25 parts by weight, for example about 10 to about 20 parts by weight, based on 100 parts by weight of the mixed resin including polycarbonate resin, polybutylene terephthalate resin and polycarbonate-polysiloxane copolymer.

In some embodiments, the polycarbonate resin composition may include the graft copolymer in an amount of about 8, 9, 10, 11, 12, 13, 14, 15, 16, 17, 18, 19, 20, 21, 22, 23, 24, or 25 parts by weight. Further, according to some embodiments of the present invention, the amount of the graft copolymer can be in a range from about any of the foregoing amounts to about any other of the foregoing amounts.

When the polycarbonate resin composition includes the graft copolymer in the amount within the above range, excellent low-temperature impact resistance and heat resistance may be obtained.

(C) Additive(s)

The polycarbonate resin composition according to one embodiment may include at least one additive. Exemplary additives include without limitation antibacterial agents, heat stabilizers, antioxidants, release agents, light stabilizers, inorganic material additives, surfactants, coupling agents, plasticizers, admixtures, stabilizers, lubricants, antistatic agents, coloring aids, flame proofing agents, weather-resistance agents, colorants, ultraviolet (UV) absorbers, ultraviolet (UV) blocking agents, flame retardants, fillers, and the like, and combinations thereof.

Exemplary antioxidants may include without limitation phenol-type antioxidants, phosphite-type antioxidants, thioether-type antioxidants, amine-type antioxidants, and the like, and combinations thereof. Exemplary release agents may include without limitation fluorine-containing polymers, silicone oils, metal salts of stearic acid, metal salts of montanic acid, montanic acid ester waxes, polyethylene waxes, and the like, and combinations thereof. Exemplary weather-resistance agents may include without limitation benzophenone-type weather-resistance agents, amine-type weather-resistance agents, and the like, and combinations thereof. Exemplary colorants may include without limitation dyes, pigments, and the like, and combinations thereof. Exemplary ultraviolet (UV) blocking agents may include without limitation titanium dioxide (TiO₂), carbon black, and the like, and combinations thereof. Exemplary fillers may include without limitation glass fibers, carbon fibers, silica, mica, alumina, clay, calcium carbonate, calcium sulfate, glass beads, and the like, and combinations thereof.

The additive may be included in a predetermined amount as long as it does not deteriorate the properties of the polycarbonate resin composition. In one embodiment, the polycarbonate resin composition may include one or more additives in an amount of about 30 parts by weight or less, for example about 0.1 to about 20 parts by weight, based on 100 parts by weight of the mixed resin including the polycarbonate resin, polybutylene terephthalate resin and polycarbonate-polysiloxane copolymer. The polycarbonate resin composition may be prepared by known methods for preparing a resin composition. For example, the constituting components and other optional additives can be simultaneously mixed and melt-extruded through an extruder to provide a pellet.

According to another embodiment, a molded product made of the above polycarbonate resin composition is provided. The molded products may be made of the polycarbonate resin composition through diverse processes such as but not limited to injection molding, blow molding, extrusion molding, thermal molding and the like. The polycarbonate resin composition may be used for diverse kinds of products that simultaneously require excellent low-temperature impact resistance and heat resistance, such as electronic parts, automobile parts, and general products, including automobile exterior components that are exposed outwardly, such as bumpers.

The following examples illustrate the present invention in more detail. However, they are exemplary embodiments and are not limiting.

A polycarbonate resin composition according to an embodiment includes the following components.

(A) Mixed Resin

(A1) Polycarbonate (PC) Resin

SC-1080 having a weight average molecular weight of 28,000 g/mol and produced by Cheil Industries is used.

(A2) Polybutylene Terephthalate (PBT) Resin

DHK 011 having an intrinsic viscosity[η] of 1.2 dl/g and produced by Shinkong Corporation is used.

(A3) Polycarbonate-Polysiloxane Copolymer

Tarflon produced by Idemitsu Kosan Co., Ltd. is used.

(B) Graft Copolymer

CHT produced by Cheil Industries is used.

(B′) Acrylonitrile-Butadiene-Styrene Graft Copolymer (q-ABS)

Metablen C223-A produced by MRC is used.

### EXAMPLES 1 to 4 AND COMPARATIVE EXAMPLES 1 to 4

Polycarbonate resin compositions according to Examples 1 to 4 and Comparative Examples 1 to 4 are prepared using the aforementioned constituting components in the amounts set forth in the following Table 1.

The components are mixed in the amounts shown in the following Table 1, extruded using a conventional twin-screw extruder, and the extruded products are prepared in the form of pellets.

### EXPERIMENTAL EXAMPLES

The manufactured pellets are dried at 100° C. for 4 hours and specimens for examining physical properties are prepared by using an injection molding machine with an injection molding capability of 6 oz and setting a cylinder temperature at 250° C., casting temperature at 60° C. and molding cycle at 30 seconds, and injection-molding ASTM specimens.

The physical properties of the physical property specimens are measured in the following methods, and the results are presented in the following Table 1.

(1) IZOD Impact strength: Measured based on ASTM D256 specification at −30° C. (thickness of specimen ⅛″).

(2) Thermal distortion temperature (HDT): Measured based on ASTM D648 specification.

(3) Gloss (60°): Measured based on ASTM D523 specification by setting BYK-Gardner Gloss Meter measurement angle at 60°.

TABLE 1

| | | Examples | | | | Comparative Examples | | | |
|---|---|---|---|---|---|---|---|---|---|
| | | 1 | 2 | 3 | 4 | 1 | 2 | 3 | 4 |
| (A) | (A1) PC resin | 50 | 35 | 30 | 45 | 40 | 50 | 40 | 50 |
| mixed | (wt %) | | | | | | | | |
| resin | (A2) PBT resin | 40 | 45 | 45 | 30 | 35 | 50 | 45 | 40 |
| | (wt %) | | | | | | | | |
| | (A3) polycarbonate- | 10 | 20 | 25 | 25 | — | — | 15 | 10 |
| | polysiloxane | | | | | | | | |
| | copolymer (wt %) | | | | | | | | |

| | | | | | | | | |
|---|---|---|---|---|---|---|---|---|
| (B) graft copolymer | 17 | 12 | 10 | 8 | — | 20 | — | — |
| (parts by weight*) | | | | | | | | |
| (B′) g-ABS | — | — | — | — | 25 | — | — | 20 |
| copolymer (wt %) | | | | | | | | |
| IZOD Impact strength | 50 | 52 | 51 | 50 | 35 | 52 | 33 | 32 |
| (kgf · cm/cm) | | | | | | | | |
| Thermal distortion | 91 | 90 | 92 | 94 | 80 | 81 | 90 | 85 |
| temperature (° C.) | | | | | | | | |
| Gloss (60°) | 89 | 90 | 90 | 93 | 91 | 90 | 91 | 92 |

*Parts by weight: a unit representing an amount based on 100 parts by weight of the mixed resin A.

It may be seen from Table 1 that Examples 1 to 4 which include a mixed resin including a polycarbonate resin, a polybutylene terephthalate resin, and a polycarbonate-polysiloxane copolymer, and a graft copolymer containing an acrylic-based compound exhibit excellent impact resistance at low temperature and heat resistance and excellent gloss on the appearances of a molded product, compared with Comparative Examples 1 to 4 that do not include at least one between the polycarbonate-polysiloxane copolymer and a graft copolymer containing an acrylic-based compound.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. The polycarbonate resin composition, comprising
(A) a mixed resin comprising
(A1) a polycarbonate resin;
(A2) a polybutylene terephthalate resin; and
(A3) a polycarbonate-polysiloxane copolymer; and
(B) a graft copolymer including an unsaturated compound including an acrylic-based compound graft-polymerized into a rubber.

2. The polycarbonate resin composition of claim 1, wherein the graft copolymer (B) is included in an amount of about 8 to about 25 parts by weight based on 100 parts by weight of the mixed resin (A).

3. The polycarbonate resin composition of claim 1, wherein the mixed resin (A) comprises:
about 20 to about 80 wt % of the polycarbonate resin (A1);
about 15 to about 70 wt % of the polybutylene terephthalate resin (A2); and
about 5 to about 30 wt % of the polycarbonate-polysiloxane copolymer (A3).

4. The polycarbonate resin composition of claim 1, wherein the polycarbonate-polysiloxane copolymer (A3) comprises about 1 to about 99 wt % of a polycarbonate block and about 1 to about 99 wt % of a polysiloxane block.

5. The polycarbonate resin composition of claim 1, wherein the polycarbonate-polysiloxane copolymer (A3) has a weight average molecular weight of about 10,000 to about 30,000 g/mol.

6. The polycarbonate resin composition of claim 1, wherein the rubber comprises a diene-based compound, a silicon-based compound, or a combination thereof.

7. The polycarbonate resin composition of claim 1, wherein the unsaturated compound further comprises a heterocyclic compound, an aromatic vinyl compound, a vinyl cyanide compound, or a combination thereof.

8. The polycarbonate resin composition of claim 1, wherein the polycarbonate resin composition further comprises at least one additive comprising an antibacterial agent, a heat stabilizer, an antioxidant, a release agent, a light stabilizer, an inorganic material additive, a surfactant, a coupling agent, a plasticizer, an admixture, a stabilizer, a lubricant, an antistatic agent, a coloring aid, a flame proofing agent, a weather-resistance agent, a colorant, an ultraviolet (UV) absorber, an ultraviolet (UV) blocking agent, a flame retardant, a filler, or a combination thereof.

9. A molded product using the polycarbonate resin composition of claim 1.
